(19) United States
(12) Patent Application Publication
(10) Pub. No.: US 2006/0222928 A1
(43) Pub. Date: Oct. 5, 2006

(54) Fuel cell system

(75) Inventors: Kazuhiro Yasuda, Yokohama-shi (JP); Hideyuki Ohzu, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/390,256

(22) Filed: Mar. 28, 2006

(30) Foreign Application Priority Data
Mar. 30, 2005 (JP) 2005-099286

(51) Int. Cl. H01M 8/04; B67D 5/00

(52) U.S. Cl. 429/34; 222/3

(57) ABSTRACT

The present invention provides fuel cell system to supply liquid fuel and air to a stack to thus cause reaction, thereby generating rated power. The fuel cell system includes a liquid fuel supply system, and an air-supply system. An air-supply rate being a volume of air supplied from the air-supply system per unit time, the air-supply rate of the air is set to a first air-supply rate upon start-up. The first air-supply rate is higher than the air-supply rate during the rated power generation.

### CROSS REFERENCE TO RELATED APPLICATIONS

This application is based upon and claims the benefit of priority from the prior Japanese Patent Application No. 2005-099286, filed on Mar. 30, 2005: the entire contents of which are incorporated herein by reference.

### BACKGROUND OF THE INVENTION

1. Field of the Invention

The present invention relates to a fuel cell system.

2. Description of the Related Art

A fuel cell using liquid fuel in a circulating manner has attracted attention as a power source for a mobile electrical apparatus, such as a small portable apparatus or a PC, and extensive development and studies have been conducted on such a fuel cell. In particular, a fuel cell of a type which sequentially supplies high-concentration methanol stored in a cartridge tank, and which uses methanol while diluting the high-concentration methanol in its fuel cell system, is advantageously convenient, in view of being capable of supplying fuel inexpensively and readily.

However, in a fuel cell of this type which directly supplies to an electrode liquid fuel, such as methanol, liquid whose main constituent is water accumulates in a cathode catalyst. This accumulation is caused by product water being generated at a cathode, and liquid fuel diffusing through a membrane. The accumulation of liquid in the cathode inhibits diffusion of air, thereby degrading performance of the fuel cell system. The timing at which this type of performance degradation occurs varies depending on power generation conditions (air-supply rate and current density during power generation). However, the degradation starts gradually when total power generating time has exceeded a certain level.

Furthermore, in a fuel cell using liquid fuel, a fuel solution remaining in a flow path during suspension of power generation passes through an electrolyte and arrives at the cathode side, thereby sometimes drastically degrading the power generation characteristic upon resumption of power generation.

As a known method for a fuel cell employing hydrogen as fuel, there has been disclosed a method which detects flooding of a cathode with water on the basis of a drop in cell voltage or a change in impedance during power generation, and which temporarily increases an airflow rate during power generation, so as to suppress drop in voltage (e.g., JP-A-7-235324).

However, due to the above reason, flooding with water in a cathode in a fuel cell, which generates power using liquid fuel such as an aqueous solution containing methanol, has already occurred in some cases prior to start of power generation. Once this phenomenon occurs, even when an airflow rate is increased by some extent during start-up operation for power generation, the fuel cell less easily recovers from the voltage-dropped state to a rated state. Accordingly, difficulty has been encountered in stabilizing the power generation capability for a long period of time.

The above-described degradation of cell characteristic resulting from inhibition of air diffusion in the cathode caused by product water in the cathode, permeation of liquid fuel in an anode flow path, and the like, easily occurs when power generation is continued (irrespective of whether power generation is continuous or intermittent (involving starting, stopping, and restarting) under a condition of low air flow rate. Generally, a fuel cell using liquid fuel; e.g., a direct methanol fuel cell (DMFC) using a methanol aqueous solution, of ten employs the following method: pure methanol is replenished; water generated during power generation is recovered; the water is mixed again with pure methanol; and the methanol aqueous solution having been diluted at a predetermined ratio is used in a power generation unit. In order to recover water generated in the cathode within a limited space, an airflow rate must be restricted (electric power must be generated with maximum efficiency with as low an airflow rate as possible). In this case, the above-described flooding of the cathode with water is likely to occur. Accordingly, the cell characteristic is degraded at an early stage, which poses difficulty in obtainment of a stable power output for a long period of time.

The degradation in characteristic as described above involves a problem that, in addition to the degradation in performance during power generation, power generation capability immediately after start-up of power generation decreases at an early stage as a total employment time becomes long.

### SUMMARY OF THE INVENTION

According to an aspect of the present invention, a fuel cell system which supplies liquid fuel and air to a cell to thus cause reaction, thereby carrying out rated power generation, includes a liquid fuel supply system, and an air-supply system. An air-supply rate being a volume of air supplied from the air-supply system per unit time, the air-supply rate of the air is set to a first air-supply rate upon start-up. The first air-supply rate is higher than the air-supply rate during the rated power generation.

### BRIEF DESCRIPTION OF THE DRAWINGS

FIG. 1 illustrates a fuel cell system of an embodiment according to the present invention; and

FIG. 2 is a fuel cell system of another embodiment according to the present invention.

### DETAILED DESCRIPTION OF THE INVENTION

The present invention will be described by reference to the embodiments. The present invention has been conceived for a fuel cell using liquid fuel in view of suppressing degradation in performance of a stack which may otherwise occur when power generation is carried out for a long period of time. The invention is particularly advantageous in suppressing degradation in performance which may otherwise be caused by flooding of a cathode with water.

When a fuel cell starts power generation from room temperature, cell temperature increases with the course of power generating time. As a result, diffusion of fuel and catalytic activity increase, and cell resistance decreases, thereby increasing a power generation output.

However, in a fuel cell of a type using liquid; e.g., liquid containing hydrogen, such as methanol, output decreases due to accumulation of liquid in the cathode upon resumption of power generation, and the like, which sometimes results in failure in obtainment of a predetermined rated output. This problem is caused by water, and the like, generated as follows: liquid having remained in an anode flow path during suspension of power generation permeates through the cathode, and is formed into water in the cathode during power generation. Even when power generation is continued under a state in which such a problem continues, the power output is not increased; furthermore, such a continuance causes a long-term decrease in power output.

According to the present invention, air is supplied upon start-up of power generation at an airflow rate higher than that of air to be supplied during rated power generation, so as to eliminate flooding of a cathode with water which causes such a decrease in power output.

The airflow rate is about 4 to 15 times the stoichiometric ratio, which is higher than the airflow rate to be supplied during the rated power generation. The reason for increasing the airflow rate above the rated flow rate (about 3 times the stoichiometric ratio) is removal of liquid, whose main constituent is water, accumulated in the cathode. Therefore, when the supply rate is lower than the foregoing value, this elimination effect cannot be yielded sufficiently. In contrast, when the airflow rate is excessively high, moisture of the electrolyte forming the cell is also removed, thereby lowering output, which is less preferable.

Meanwhile, in a power generation unit whose power source is a fuel cell using liquid fuel, product water is recovered and reused during rated power generation. When air is supplied at an airflow rate higher than that during the rated power generation so as to maintain power generation capability for a long period of time as described above, recovery of water encounters difficulty. Therefore, the period of time within which the airflow rate is higher than that during the rated power generation is preferably as short as possible. The period of time preferably falls within a range of 5 to 60 minutes, more preferably 5 to 30 minutes, still more preferably 5 to 15 minutes.

The airflow rate and the period of time during which the air is supplied may be adjusted on the basis of determination of a voltage in the power-generating state (an open-circuit voltage, or a voltage at a predetermined current value). Moisture control of the cell can be attained by means of carrying out such an adjustment, which is preferable.

For increasing the airflow rate, a pump in an air-supply system employed in regular rated power generation may be used. Alternatively, an air-supply system other than the foregoing air-supply system may be employed as an auxiliary only when an increase in the airflow rate is desired. When a pump of the other air-supply system is employed as an auxiliary, power consumption for auxiliaries during the rated power generation can be reduced, which is particularly preferable.

Next, when air is supplied from the other air-supply system, and, in addition, an auxiliary power source, such as a lithium secondary battery or a capacitor, is employed as a drive power source of the air-supply system for supplying air at the thus-increased air-supply rate, the total power consumption for the auxiliaries and the volume of the auxiliaries in the air-supply system can be decreased, and surplus power of a fuel cell main body can be stored in a case where the auxiliary power source capacity is insufficient, which is preferable.

Flooding of the cathode with water is likely to occur in the vicinity of an exhaust side of the cell, and the area flooded with water is likely to increase during long-term use. Hence, reversing the direction along which air is supplied upon start of power generation for the purpose of preventing localization of such flooding is effective for resolving the flooding with water, thereby maintaining the cell characteristic stable for a long term. In addition, when the direction along which air is supplied is reversed at irregular intervals while an open-circuit voltage upon start-up of power generation by the cell, a voltage during power generation, and a change in current are controlled, fine adjustment can be provided, which is preferable. Alternatively, the reversing may be performed regularly in accordance with the number of start-up operations or an elapsed generating time.

Meanwhile, in order to suppress flooding with water which may otherwise be caused on the cathode side, the electrode area is preferably as small as possible, and the path from an inlet to an exhaust side of the cathode in the stack in the air-supply system is preferably short. Therefore, air is preferably supplied via paths which are divided into as many paths as possible from the inlet to an exhaust port of the cathode. When the number of flow paths on the cathode side is about one or two per 10 cm², the area per flow path becomes small. Consequently, flooding with water less easily occurs, thereby stabilizing long-term performance.

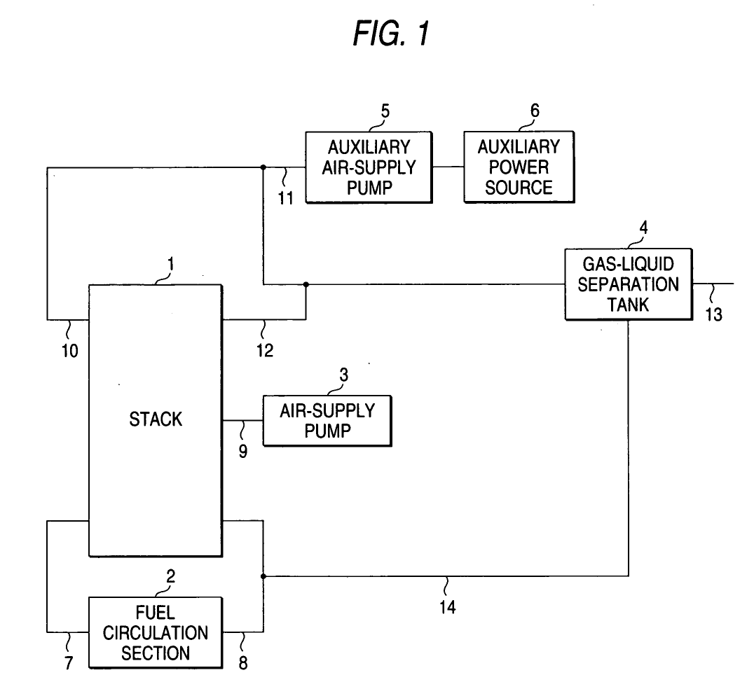

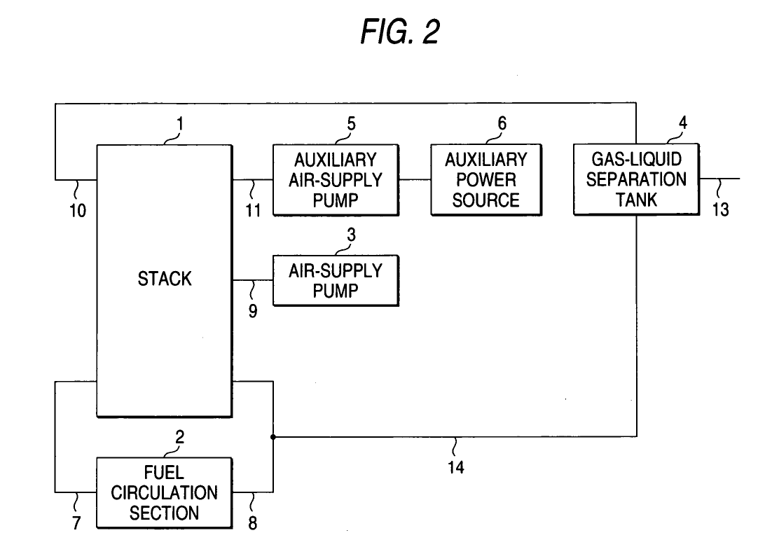

A fuel cell system will be described specifically by reference to FIGS. 1 and 2.

In a fuel cell system illustrated in FIG. 1, a methanol aqueous solution is supplied by means of a fuel circulation section 2, and air is supplied by means of an air-supply pump 3 during the rated power generation, thereby generating rated power. The methanol aqueous solution for use in power generation is supplied from the fuel circulation section 2 to a stack 1 by way of piping 7, and liquid having been used in power generation returns to the fuel circulation section 2 by way of piping 8. In the fuel circulation section 2, a concentration of the methanol is adjusted, and the methanol is again supplied to the stack 1 by way of the pipe 7. By virtue of this configuration, the stack 1 is continuously supplied with methanol and water, which are required by the stack 1.

Air is supplied from the air-supply pump 3 to the stack 1 by way of piping 9. Air containing water vapor having been subjected to power generation is sent to a gas-liquid separation tank 4 by way of piping 10, to thus be separated into liquid and gas in the gas-liquid separation tank 4. Thereafter, the liquid is sent to the fuel circulation section 2 by way of piping 14; and the gas is exhausted to the outside by way of piping 13.

The fuel cell system of the invention maintains long-term stability in terms of power generation capability by the stack 1 by means of supplying air to the stack 1 at an air-supply rate higher than that during rated power generation with use of an auxiliary air-supply pump 5 by way of piping 11 and subsequently the pipe 10. The thus-supplied air is released to the outside from the stack 1 by way of piping 12. In this release, the air maybe either sent to the gas-liquid separation 4 as illustrated in FIG. 1, or released directly to the outside.

The auxiliary air-supply pump 5 is activated with power supplied from an auxiliary power source 6. The auxiliary power source 6 preferably employs a secondary battery, such as a lithium battery, or a capacitor, so as to carry out efficient and stable air supply.

The fuel cell system illustrated in FIG. 2 is substantially identical in configuration with the system illustrated in FIG. 1, except in the direction of air supply during a period within which air is supplied to the stack 1 at an air-supply rate higher than a rated air-supply rate by the auxiliary pump.

For supplying air to the stack 1 at the air-supply rate higher than the rated air-supply rate with use of the auxiliary air-supply pump 6, the air may be supplied through an exhaust port for use in rated power generation as illustrated in FIG. 1, or may be supplied in the same direction as that of the air-supply pump 3 as illustrated in FIG. 2. However, the air supplied by the auxiliary pump 6 is preferably supplied through the exhaust port as illustrated in FIG. 1, since flooding with water occurs in the vicinity of the exhaust port for use in the rated power generation.

The airflow rate of air to be supplied to the cathode side for attaining power generation of a certain electric current density with use of liquid fuel, such as methanol, is expressed by the following formula:
2H⁺+½O₂+2e⁻→H₂O
In this reaction, electrons of 1 mole react with ¼ mole of oxygen. Since 1 mole of an ideal gas has a volume of 22.4 L=22.4×1,000 (cc), and air contains 21% oxygen, the air-supply rate required for obtaining an electric current I is calculated as follows: the air-supply rate (cc/min/cm²)=I (mA/cm²)/1,000/96,500×¼×22.4×1,000×60×(100/21). When I is 50 mA/cm², an airflow rate of 0.83 cc/min/cm² is obtained as the supply rate corresponding to the stoichiometric ratio. In a case where rated power generation is carried out at 100 to 200 mA/cm², 1.66 to 3.32 cc/min/cm² is obtained as the airflow rate corresponding to the stoichiometric ratio. The air-supply rate during power generation according to the invention is 4 to 15 times that during rated power generation the stoichiometric ratio. In a case where power generation rating is 100 mA/cm², the airflow rate corresponding to the stoichiometric ratio is 1.66 cc/min/cm². Therefore, the air-supply rate according to the invention falls within a range of 6.64 (4 times) to 24.9 (15 times) cc/min/cm² is obtained.

### EXAMPLE 1

A power generation including a stack formed from 30 cells each having an electrode area of 10 cm² (with a single cathode flow path in each of the electrode members) and which uses methanol was fabricated. The unit was a unit which generated power with use of a methanol aqueous solution of about 3% by means of replenishing pure methanol, and mixing, at a predetermined ratio, product water having been generated within the unit and the pure methanol. This unit generated power as a power source for a PC at a rated voltage of 15 V (1.5 A, an air-supply rate required in the stoichiometric ratio: 853 cc); and supplied air at an airflow rate of 3 L (about 3.52 times the stoichiometric ratio) during power generation. The generating time was 8 to 14 hours on average. When the unit was activated one week after startup of power generation, an open circuit voltage at start-up was 21 V, which was lower than the initial set value of 23 to 25 V. Accordingly, the unit was activated while the airflow rate was increased to 3.412 L (about 4.0 times the stoichiometric ratio). As a result, the open circuit voltage was ascertained to have recovered to 25 V, and the voltage during rated power generation was also ascertained to be 15 V or higher. (The period within which the airflow rate was increased to 4.3 L was 20 minutes after start-up (i.e., until reaching the rated output). Subsequently, the airflow rate was returned to the rated flow rate of 3 L, at which continuous power generation was carried out for 13 hours. In addition, the power source for an air-supply system at start-up was fed from an auxiliary power source (a secondary battery) inside or outside the unit.) Power was generated on a daily basis while the power generation capacity was maintained by means of varying the airflow rate while the open circuit value at start-up was monitored as described above.

This unit exhibited a variation in rated output of 5% even after total generating time exceeded 2,000 hours, and supplied stable electric power.

### EXAMPLE 2

A power generation including a stack formed from 30 cells each having an electrode area of 10 cm² (with a single cathode flow path in each of the electrode member) and which uses methanol was fabricated. The unit was a unit which generated power with use of a methanol aqueous solution of about 3% by means of replenishing pure methanol, and mixing product water having been internally generated and a predetermined amount of the pure methanol. This unit generated power as a power source for a PC at a rated voltage of 15 V (1.5 A, an air-supply rate required in the stoichiometric ratio: 853 cc). Upon start-up of power generation, for the first three minutes of which only air was supplied in an unloaded state, air was supplied at an air flow rate of 4.5 L (about 5.28 times the stoichiometric ratio) Subsequently, power generation was carried out for 10 to 30 minutes, within which the unit was ascertained to be generating electric power reaching the rated condition. Thereafter, the airflow rate was returned to the rated supply of 3 L. The generating time was 8 to 14 hours on average. In addition, the power source for an air-supply system at the start-up was fed from an auxiliary power source (a secondary battery) inside or outside the unit. This unit performing the above-described power generation process exhibited a variation in rated output of 5% or less even after total generating time exceeded 2,000 hours, and supplied stable electric power.

### EXAMPLE 3

A power generation including a stack formed from five cells each having an electrode area of 20 cm² (with two cathode flow paths in each of the cell) and which uses methanol was fabricated. The unit was a unit which generated power with use of a methanol aqueous solution of about 6% by means of replenishing pure methanol, and mixing product water having been internally generated and a predetermined amount of the pure methanol. This unit generated power as a power source for a PDA at a rated power of 4 W (2 A−2 V(0.4×5 V), an air-supply rate required in the stoichiometric ratio: 189.6 cc); and supplied air at an airflow rate of 0.568 L (3 times the stoichiometric ratio) during power generation. The generating time was 8 to 14 hours on average.

When the output value fell short of 3.6 W upon start-up of power generation, air was supplied at an airflow rate of about two to three times (6 to 9 times the stoichiometric ratio) the predetermined airflow rate was supplied for 10 to 30 minutes. When the rated output of 4 W was ascertained to be satisfied, the airflow rate was returned to the rated supply, and continuous power generation was carried out. With use of such a method for recovering the power generation capability by means of varying the airflow rate upon start-up, power generation was carried out on a daily basis.

This unit exhibited a variation in rated output of 5% or less even after total generating time exceeded 2,000 hours, and supplied stable electric power.

### EXAMPLE 4

A power generation including a stack formed from 30 cells each having an electrode area of 10 cm² (with a single cathode flow path in each of the cell) and which uses methanol was fabricated. The unit was a unit which generated power with use of a methanol aqueous solution of about 3% by means of replenishing pure methanol, and mixing product water having been internally generated and a predetermined amount of the pure methanol. This unit generated power as a power source for a PC at a rated voltage of 15 V (1.5 A, an air-supply rate required in the stoichiometric ratio: 853 cc); and supplied air at an airflow rate of 12.795 L (about 15 times the stoichiometric ratio) during power generation. The generating time under the rated condition was 8 to 14 hours on average.

In this power generation test, a mechanism for changing a direction along which air is supplied in the cathode every three start-stop operations is also incorporated in this system.

This unit exhibited a variation in rated output of 5% or less even after total generating time exceeded 3,000 hours. Accordingly, the unit supplied stabled electric power even when substantially lacking any mechanism for stabilizing power generation capability by means of increasing the airflow rate upon start-up of power generation.

The foregoing Examples 1 to 4 reveal that supply of stable electric power can be achieved by means of setting the airflow rate of the air, to be supplied for liquid fuel, at 4 to 15 times the stoichiometric ratio.

### COMPARATIVE EXAMPLE 1

A power generation including a stack formed from 30 cells each having an electrode area of 10 cm² (with a single cathode flow path in each of the cells) and which uses methanol was fabricated. The unit was a unit which generated power with use of a methanol aqueous solution of about 3% by means of replenishing pure methanol, and mixing product water having been internally generated and a predetermined amount of the pure methanol. This unit generated power as a power source for a PC at a rated voltage of 15 V (1.5 A, an air-supply rate required in the stoichiometric ratio: 853 cc); and supplied air at an airflow rate of 3 L during power generation. The generating time was 8 to 14 hours on average. Power generation was carried out on a daily basis without changing the airflow rate from the initial power generation condition. This unit started to exhibit a decrease in electric current value after total generating time exceeded 300 hours. When generating time reached about 800 hours, the output decreased to 80% of the rated output or lower, and encountered difficulty in supplying stable electric power.

### COMPARATIVE EXAMPLE 2

A power generation unit including a stack formed from 30 cells each having an electrode area of 10 cm² (with a single cathode flow path in each of the electrode members) and which uses methanol was fabricated. The unit was a unit which generated power with use of a methanol aqueous solution of about 3% by means of replenishing pure methanol, and mixing product water having been internally generated and a predetermined amount of the pure methanol. This unit generated power as a power source for a PC at a rated voltage of 15 V (1.5 A, an air-supply rate required in the stoichiometric ratio: 853 cc). At the start-up of power generation—for the first three minutes of which only air was supplied in an unloaded state—air was supplied at an airflow rate of 2.986 L (about 3.5 times the stoichiometric ratio). Subsequently, power generation was carried out for 10 to 30 minutes, within which the unit was ascertained to be generating electric power reaching the rated condition. Thereafter, the airflow rate was returned to the rated supply of 3 L. The generating time was 8 to 14 hours on average. In addition, the power source for the air-supply system upon start-up was supplied from an auxiliary power source (a secondary battery) inside or outside the unit. Power generation capability of this unit, which performs the above-described power generation process, started to gradually decrease when total generating time was about 100 hours. When the same exceeded 1,000 hours, the rated output decreased by as much as 20%.

### COMPARATIVE EXAMPLE 3

A power generation unit including a stack formed from 30 cells each having an electrode area of 10 cm² (with a single cathode flow path in each of the cell) and which uses methanol was fabricated. The unit was a unit which generated power with use of a methanol aqueous solution of about 3% by means of replenishing pure methanol, and mixing product water having been internally generated and a predetermined amount of the pure methanol. This unit generated power as a power source for a PC at a rated voltage of 15 V (1.5 A, an air-supply rate required in the stoichiometric ratio: 853 cc). Upon start-up of power generation, for the first three minutes of which only air was supplied in an unloaded state, air was supplied at an airflow rate of 13.648 L (about 16 times the stoichiometric ratio). Subsequently, power generation was carried out for 10 to 30 minutes, within which the unit was ascertained to be generating electric power reaching the rated condition. Thereafter, the airflow rate was returned to the rated supply of 3 L. The generating time was 8 to 14 hours on average. In addition, the power source for an air-supply system at the start-up was supplied from an auxiliary power source (a secondary battery) inside or outside the unit. Cell resistance of this unit performing such a power generation process increased about 50 hours after the unit started power generation. When a total generating time exceeded 1,000 hours, the rated output decreased by as much as 15%.

The present invention relates to a fuel cell using liquid fuel, and suppresses degradation of the cell in characteristics by means of controlling an airflow rate of an air-supply system.

What is claimed is:

1. A fuel cell system configured to supply liquid fuel and air to a stack to cause reaction, thereby generating rated power, comprising:
a liquid fuel supply system; and
an air-supply system, wherein
an air-supply rate being a volume of air supplied from the air-supply system per unit time, the air-supply rate of the air is set to a first air-supply rate upon start-up, and
the first air-supply rate is higher than an air-supply rate during rated power generation.

2. The fuel cell system according to claim 1, wherein
the first air-supply rate falls within a range of 4 to 15 times, in stoichiometric ratio, an air-supply rate required for the rated power generation.

3. The fuel cell system according to claim 2, wherein
the first air-supply rate falls within a range of 6 to 9 times, in stoichiometric ratio, the air-supply rate required for the rated power generation.

4. The fuel cell system according to claim 1, wherein
a period of time for the air-supply rate to change to the first air-supply rate falls within a range of 5 to 60 minutes.

5. The fuel cell system according to claim 4, wherein
the period of time for the air-supply rate to change to the first air-supply rate is 30 minutes or shorter.

6. The fuel cell system according to claim 5, wherein
the period of time for the air-supply rate to change to the first air-supply rate is 15 minutes or shorter.

7. The fuel cell system according to claim 1, wherein
a voltage under a power-generating state is detected, and
the air-supply rate is adjusted on the basis of the detected voltage.

8. The fuel cell system according to claim 7, wherein
a period of time for the air-supply rate to change to the first air-supply rate is adjusted on a basis of the detected voltage.

9. The fuel cell system according to claim 1, wherein
the air-supply system is supplied with electric power from an auxiliary power source other than electric power generated by the stack.

10. The fuel cell system according to claim 1, wherein
another air-supply system is employed when the air-supply rate is changed to the first air-supply rate.

11. The fuel cell system according to claim 1, wherein
a direction of air supplied by the air-supply system is reversed every start-up operation at irregular intervals.

12. The fuel cell system according to claim 1, wherein
a direction of air supplied by the air-supply system is reversed every start-up operation at regular intervals.

13. The fuel cell system according to claim 12, wherein
an interval of reversing is determined on a basis of a number of start-up operation or an elapsed generating time.

14. The fuel cell system according to claim 1, wherein
a number of a flow path on a cathode side of the supply system for the liquid fuel is one or two per 10 cm² of an electrode area of the cell.

15. The fuel cell system according to claim 1, wherein
air having been supplied to the stack is exhausted to an outside when the air-supply rate is changed to the first air-supply rate.

16. An air-supply device configured to supply air to a fuel cell to generate rated power, wherein
an air-supply rate being a volume of air supplied from the air-supply system per unit time, the air-supply rate of the air is set to a first air-supply rate upon start-up, and
the first air-supply rate is higher than an air-supply rate during rated power generation.

17. The air-supply device according to claim 16, wherein
the first air-supply rate falls within a range of 4 to 15 times, in stoichiometric ratio, an air-supply rate required for the rated power generation.

18. The air-supply device according to claim 17, wherein
the first air-supply rate falls within a range of 6 to 9 times, in stoichiometric ratio, the air-supply rate required for rated power generation.

19. The air-supply device according to claim 16, wherein
a period of time for the air-supply rate to change to the first air-supply rate falls within a range of 5 to 60 minutes.

20. The air-supply device according to claim 19, wherein
the period of time for the air-supply rate to change to the first air-supply rate is 30 minutes or shorter.

21. The air-supply device according to claim 20, wherein
the period of time for the air-supply rate to change to the first air-supply rate is 15 minutes or shorter.

22. The air-supply device according to claim 16, wherein
the air-supply rate is adjusted on a basis of a voltage under a power-generating state of the fuel cell.

23. The air-supply device according to claim 22, wherein
a period of time for the air-supply rate to change to the first air-supply rate is adjusted on a basis of the voltage in a power-generating state of the fuel cell.

24. The air-supply device according to claim 16, wherein
electric power is supplied from an auxiliary power source other than electric power generated by a stack of the fuel cell.

25. The air-supply device according to claim 16, wherein
another air-supply system is employed when the air-supply rate is changed to the first air-supply rate.

26. The air-supply device according to claim 16, wherein
a direction of the supplied air is reversed every start-up operation, at irregular intervals.

27. The air-supply device according to claim 16, wherein
a direction of the supplied air is reversed every start-up operation at regular intervals.

28. The air-supply device according to claim 27, wherein
an intervals of reversing is determined on a basis of a number of start-up operation or an elapsed generating time.

29. The air-supply device according to claim 16, wherein
air having been supplied to a stack of the fuel cell is exhausted to an outside when the air-supply rate is changed to the first air-supply rate.
